(19) United States
(12) Patent Application Publication
(10) Pub. No.: US 2026/0095439 A1
(43) Pub. Date: Apr. 2, 2026

(54) HANDLING UNKNOWN UNICAST TRAFFIC ON BORDER NETWORK DEVICES IN A VLAN

(71) Applicant: HEWLETT PACKARD ENTERPRISE DEVELOPMENT LP, Spring, TX (US)

(72) Inventors: Saumya Dikshit, Bangalore (IN); Pramod Kumar A S, Bangalore (IN)

(21) Appl. No.: 19/025,419

(22) Filed: Jan. 16, 2025

(30) Foreign Application Priority Data
Sep. 30, 2024 (IN) 202441073797

(51) Int. Cl. H04L 9/40

(52) U.S. Cl. CPC H04L 63/029; H04L 63/0272; H04L 63/0428; H04L 63/20

(57) ABSTRACT

Efficient implementation of network routing of unknown media access control (MAC) using unknown MAC routes (UMRs) and multiple broadcast groups. Specifically, a system includes a network device that is configured to manage communications between a first fabric in a LAN and a second fabric in the LAN using a split horizon rule that block retransmission of a message to network devices that have transmitted. The network device is also configured to, on receipt of a packet from within the first fabric for a host with the unknown MAC address, override the split horizon rule and transmit the packet back into the first fabric from the LAN network device based at least in part on the receipt of the packet for the host with the unknown MAC address.

### BACKGROUND

An Ethernet virtual private network (EVPN) is a wide area network (WAN) technology that connects different network sites/fabrics/segments using layer 2 (L2) and layer 3 (L3) connectivity while allowing multiple network sites/fabrics/segments to be deployed. For instance, EVPN may be used to implement a virtual private network (VPN) solution that provides a unified structure for control and data planes. The EVPN integrates the different control planes to separate a forwarding plane from the control plane to improve traffic balance and flexibility in deployment and operation. EVPN may be used in an extensible local area network (VXLAN). EVPN VXLAN is an overlay solution that provides multi-fabric deployments the ability to connect dispersed customer sites using a virtual bridge. In other words, EVPN VXLANs provide stretched VLANs or L2 extensions enable a single VLAN to be used across different physical locations.

### DRAWINGS

Features, aspects, and advantages of the present disclosure will become better understood when the following detailed description is read with reference to the accompanying drawings in which like characters represent like parts throughout the drawings, wherein:

FIG. 1 is a diagram illustrating a system that includes multiple fabrics across which a virtual extensible local area network extends using border network devices that publish unknown media access control routes, in accordance with aspects of the present disclosure;

FIG. 2 is a diagram of the system of FIG. 1 showing a packet being blocked from being retransmitted back into the fabric from which it is transmitted to a border network device using a split horizon rule, in accordance with aspects of the present disclosure;

FIG. 3 is a diagram of connections of the border network device of FIGS. 1 and 2 showing a tunnel outside of a fabric and tunnels within the fabric to internal virtual local area network tunnel end points, in accordance with aspects of the present disclosure;

FIG. 4 is a diagram illustrating a process for a local area network device to implement packet routing by overriding the split horizon rule for packets with unknown media access control address destinations, in accordance with aspects of the present disclosure;

FIG. 5 is a diagram illustrating a process for a network device to implement packet routing by retransmitting, back into a fabric, unicast messages with an unknown media access control address destination and blocking retransmission of multicast messages back into the fabric, in accordance with aspects of the present disclosure; and

FIG. 6 is a flow diagram of a process that may be deployed as a decision tree by a network device to implement packet routing and transmission of packets according to corresponding replication/broadcast groups, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Aspects provided herein relate to techniques for utilizing EVPN VXLAN and/or other network overlays to unknown MAC addresses while enhancing/optimizing MAC table scales. For instance, one way of processing such unknown MAC addresses may include border network devices publishing an unknown MAC route (UMR) to reduce an amount of unknown-unicast traffic in one or more data centers corresponding to the EVPN VXLAN. UMR curtails or limits the MAC scale by having border network devices publish UMRs to act as default routes for any unknown destination MAC located on the access switches. This helps optimize MAC table scales and helps the border network devices to absorb the MAC scale while also providing a proxy gateway to remote fabric hosts. The problem with UMR handling is that the handling of unknown MACs consumes significant resources for the border network device and internal network devices may miss out on the unknown MAC packet broadcast to the border network device to the UMR potentially causing some unknown MAC packets to be unable to reach their target destination/nodes.

To address the issues with UMR handling, handling of unknown MAC address unicast traffic in an application-specific integrated circuit (ASIC) may be made by handling unknown unicast traffic to border routers publishing the UMR routes using a VXLAN network identifier (VNI). In other words, handling UMR may cause unicast UMR traffic to be reflected back into the fabric to make sure that nodes are not missed for UMR traffic due to a split horizon rule to reduce network traffic. A split-horizon rule may be implemented as part of a border gateway protocol (BGP) or other protocols, such Enhanced Interior Gateway Routing Protocol (EIGRP) or Routing Information Protocol (RIP), that prevents routing loops by not advertising routes back to the neighbor that originally sent them. Routing loops may cause network inefficiencies, routing table inflation, and/or complete routing failures. One way to avoid such loops is to prevent UMR messages from being broadcast back into a network/fabric/segment from which the messages are received as part of the split horizon rule. However, blocking such transmissions may cause some nodes to be completely missed when targeted by a message with an unknown UMR. For example, silent hosts may be missed when targeted by a message with an unknown UMR. A silent host a network device that has not sent or received any communications from the VXLAN.

To address this issue, a temporary and/or alternative broadcast group is created and used to broadcast unicast traffic back into the fabric to identify whether the unicast traffic is targeting a node (e.g., silent host) in the fabric. The broadcasting of the packets back into the fabric includes broadcasting the packets into every tunnel except for the tunnel from which the node received the packets thereby enabling the traffic to be relayed to silent hosts and potentially discover them with an appropriate response, such as an address resolution protocol (ARP) response.

Specifically, broadcast, unknown-unicast and multicast traffic (BUM traffic) arriving on a specific tunnel and VNI/Vlan is redirected based on a dynamically assigned special/different/secondary replication (broadcast) group. As discussed below, retransmitting of broadcast and multicast traffic is treated differently than unicast unknown destination MAC traffic. Instead of mapping the retransmit to a default replication group assigned as part of normal provisioning and used for broadcast and multicast traffic, unknown destination MAC traffic may be sent to the secondary replication group. For packets carrying unknown destination MAC tags, a switch decapsulates the packets and overrides the default action of following a split horizon rule and checks for any published UMRs. If there is a UMR, the switch picks the secondary replication group as the broadcast replication group. In other words, if there is a published UMR for the unknown destination MAC, the packets are broadcast back into a fabric rather than out of the fabric using the UMR.

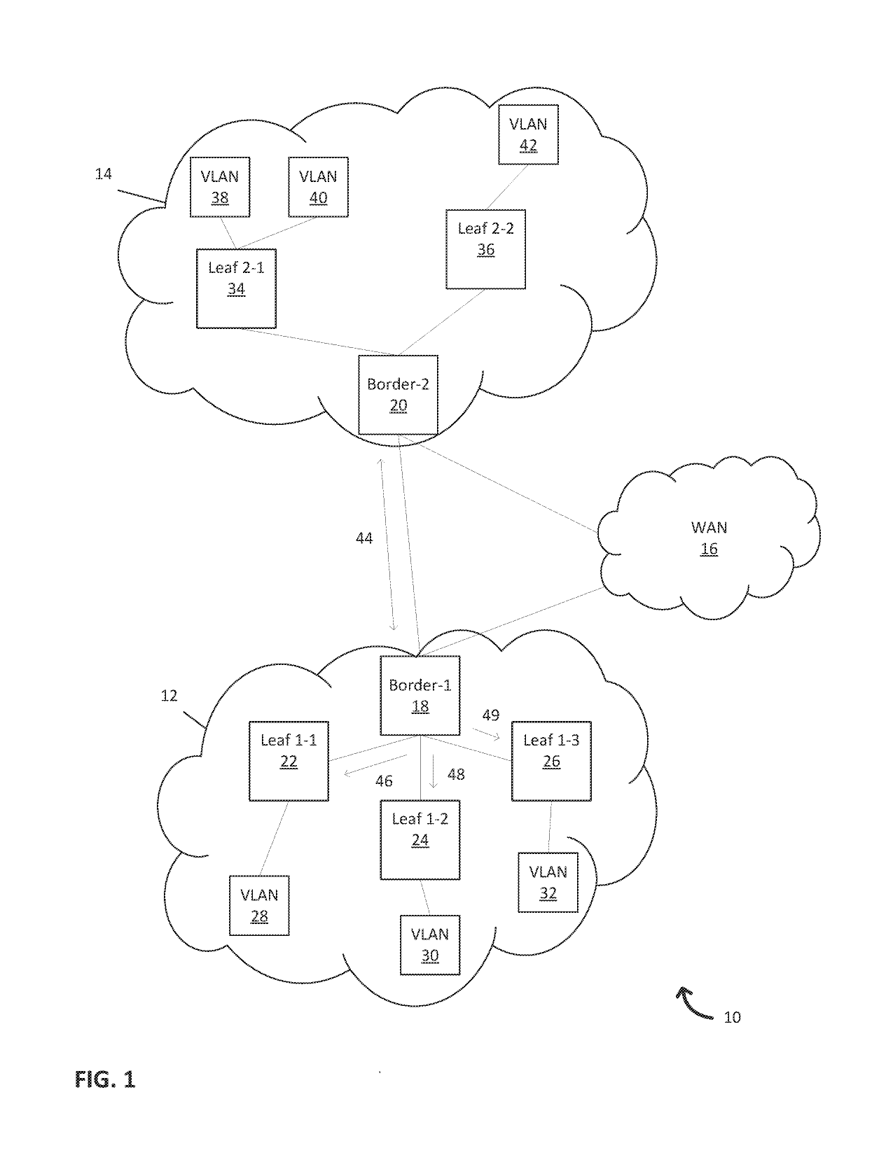

With the foregoing in mind, FIG. 1 is a diagram illustrating a system 10 that includes a fabric 12 and a fabric 14. The fabrics 12 and 14 each include a network of connected devices as part of a network site and/or a network segment. A network site is a physical location (e.g., server room, building, data center, etc.) while a network segment may be a portion of a computer network. The system 10 may be used to implement at least part of a virtual extensible local area network (VXLAN) that overlays at least parts of the fabric 12 and the fabric 14 that each include networks and/or network portions as part of their structure. As such, the fabric 12 and/or the fabric 14 may be different networks, different network segments, different network locations, or a combination thereof. The fabric 12 includes a border network device 18, and the fabric 14 includes a border network device 20. The border network devices 18 and 20 may act as routers and/or switches in the system 10. The border network device 18 and the border network device 20 may each be a local area network (LAN) network device that acts as a tunnel endpoint that encapsulates and decapsulates packets for communication between one or more portions of the underlay network(s) (e.g., the fabric 12 and/or the fabric 14) and the overlay network (e.g., EVPN VXLAN). As such, each of the network devices, whether border network devices and/or access switches, may provide tunnel endpoints to secure communication with other devices of the system 10 using the EVPN VXLAN. Furthermore, the border network device 18 and the border network device 20 enable secure communications within the EVPN VXLAN via a secured tunnel between the border network device 18 and the border network device 20 that encapsulates and decapsulates data exchanged between the fabric 12 and the fabric 14. The secured tunnel may be implemented at least partially through a wide area network (WAN) 16, such as the Internet, cellular networks, and/or a combination of such networks.

The fabric 12 also includes network devices 22, 24, and 26 that may act as access switches that enable the fabric 12 to connect VLAN devices 28, 30, and 32 to other devices in the fabric 12. For instance, the network devices 22, 24, and 26 may be access devices that directly interact with end-user devices and connect distribution layer switches/border routers to end-user devices, such as the VLAN devices 28, 30, and 32. The network devices 22, 24, and/or 26 may act as leaves of the network that provide access to the respective VLAN devices 28, 30, and 32. At least some of the VLAN devices 28, 30, and/or 32 may be part of the EVPN VXLAN as end-user devices that may provide some functionality within the VXLAN. As such, the VLAN devices 28, 30, and/or 32 may include any electronic device that may be connectable to the EVPN VXLAN to provide monitoring, control, and/or other connected functions for such devices. For instance, the VLAN devices 28, 30, and/or 32 may include desktop computers, laptop computers, workstations, printers, servers, tablet computers, wearable devices, mobile devices, cellular devices, automation devices, thermostats, security systems, automobiles, streaming media devices (e.g., cameras), and/or other Internet of Things (IoT) devices that may gain benefit from being connected together via an EVPN VXLAN. Like the fabric 12, the fabric 14 may also include network devices 34 and 36 that enable the fabric 14 to connect to VLAN devices 38, 40, and 42. As such, the network devices 34 and 36 may act as leaves of the network that provide access to the respective VLAN devices 38, 40, and 42 from other devices in an EVPN VXLAN, such as the border network device 20 and/or other network devices 34 and/or 36 with or without their respective connected VLAN devices. Similar to the VLAN devices 28, 30, and/or 32, the VLAN devices 38, 40, and/or 42 may be any suitable network-capable device, such as those listed previously. Inside a fabric, the various network devices that have previously been discussed as vteps may provide tunnels to each other to provide secure in VLAN communication between the network devices.

In some implementations, some portions of the fabric 12 and/or the fabric 14 may be included in a first EVPN VXLAN while other portions may be in other EVPN VXLANs. For instance, the VLAN devices 28, 32, and 42 may be part of the same EVPN VXLAN stretched across the fabric 12 and the fabric 14 using the border network devices 18 and 20 along with network devices 22, 26, and 36. For instance, the fabric 12 and the fabric 14 may be located at different physical locations (e.g., rooms, buildings, data centers, cities, etc.). Other devices, such as the VLAN devices 30 and 38 may be included in a second EVPN VXLAN via the border network devices 18 and 20 along with network devices 24 and 34 while VLAN device 40 is in a third EVPN VXLAN wholly in the fabric 14. For the purposes of discussion, a single VXLAN may have three hosts connected: the VLAN devices 28, 32, and 42. Border network devices 18 and 20 communicate UMR through connection 44. The border network device 18 publishes the UMR over BGP-EVPN Route Type-2 for the VXLAN to network devices 22, 24, and 26 over paths 46, 48, and 49. At least some of the devices in the same VXLAN may have corresponding tunnels between them. For instance, the network devices 22 and 26 may have a tunnel between them while also each having a respective tunnel between the border network device 18 and themselves. On the border network device 18, tunnels towards the network devices 22 and 26 may be placed in different broadcast groups to ensure that BUM traffic hitting the border network device 18 from the fabric 12 are not flooded back to the fabric 12 as it is expected that internal VXLAN tunnel end point (vteps), such as network devices 22 and 26, have a direct tunnel between them. However, BUM traffic is not reflected back to the fabric 12 by the border network device 18 to honor the split horizon rule to avoid duplicated copies of packets. In other words, due to UMR, all devices in the fabric 12 will transmit unicast messages to an unknown MAC to the border network device 18, but the border network device 18 cannot broadcast back into the fabric 12 and honor the split horizon rule.

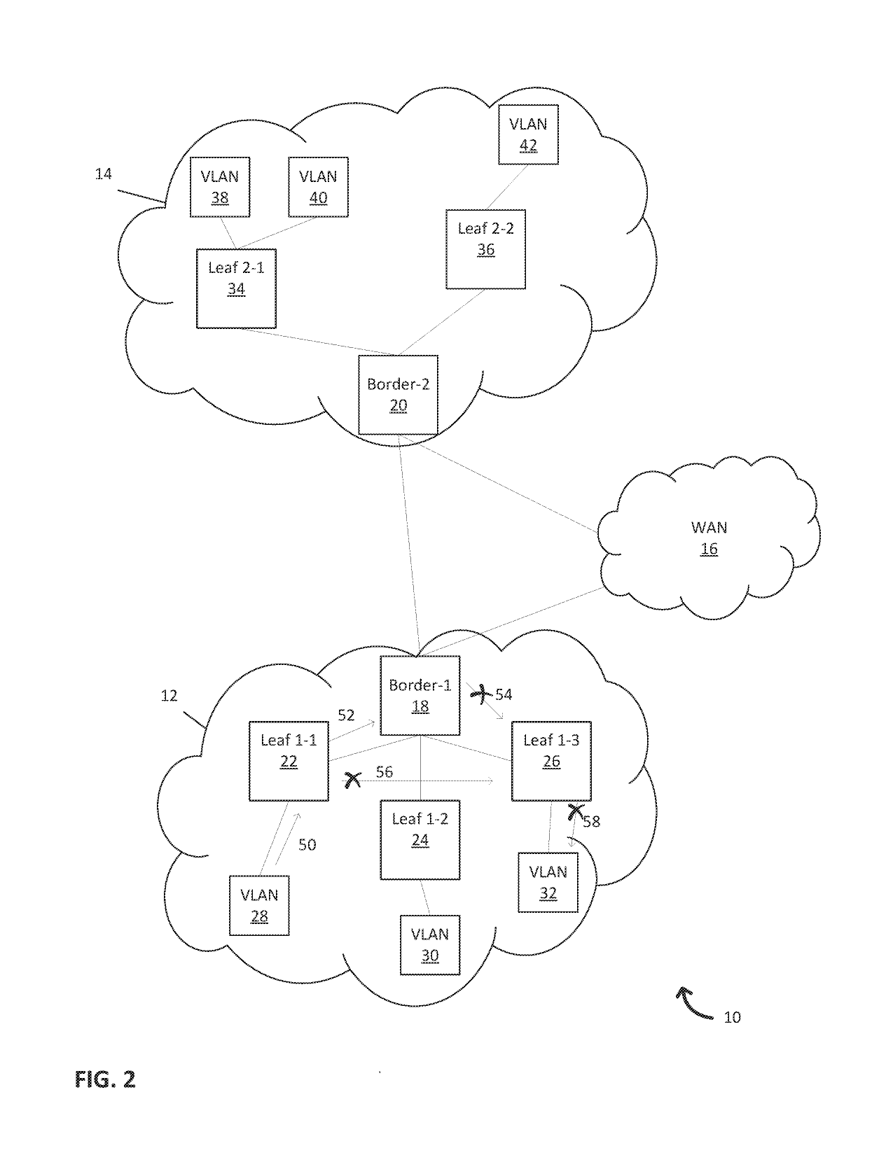

This combination of application of a split horizon rule and UMR may cause issues with silent hosts. For instance, as illustrated in FIG. 2, if VLAN device 28 wants to communicate with VLAN device 32 and has its credentials, the VLAN device 28 may send a packet 50 to a first hop vtep, network device 22. If the network device 22 has no knowledge about the VLAN device 32, it processes the packet against UMR entries in its MAC table/database. The network device 22 may have no knowledge about the VLAN device 32 if the VLAN device 32 is a silent host that has not sent or received any communications from the VXLAN yet. As a result of processing the packet 50 against the UMR entry, the network device 22 unicasts the packet 50 to the border network device 18 as packet 52 rather than using typical BUM messaging and flooding the packet 50 to the fabric 12 as packet 54. As the border network device 20 has no knowledge about the VLAN device 32 either, it floods the packet 50 to the border network device 18 in the fabric 14 but will avoid flooding the packet 50 back into the fabric 12 as packets 56 and 58. Thus, if the VLAN device 32 remains silent for some reason, the traffic intended for the VLAN device 32 will be unable to reach the VLAN device 32 and instead will be continuously flooded over remote fabrics (e.g., the fabric 14). This fruitless continuous flooding leads to bandwidth waste for the system 10. Furthermore, this anomaly may be leveraged as a security loophole for denial-of-service attacks. This can be particularly problematic if the remote fabric (e.g., the fabric 14) hosts important services. In other words, handling unknown MAC packets can consume a large amount of resources for the border network device 18 and/or the border network device 20 while internal vteps may miss out receiving the unknown MAC packets as the first-hop vtep relies on the unknown MAC packet to its border network device owning the UMR instead of legacy flood and learn treatment that may be part of BUM messaging.

To address the issues with unicast unknown MAC packets in VLANs, the control of routing may be performed by border routers publishing the UMR in BGP-EVPN routing for a particular VNI. Specifically, the border network device receiving UMR packets may determine to transmit packets back into the local fabric from which the packet was received to ensure that the packet is not targeting a silent host in the fabric that would not be received at the targeted host if a split horizon rule is followed for UMR messaging. However, a split horizon rule should not be avoided for broadcast or multicast messaging. Accordingly, unicast messaging (e.g., unicast unknown MAC packet) may be treated differently than broadcast or multicast messaging where unicast UMR packets are relayed back into the fabric to all tunnels of the border network device other than the one from which the packet was received to ensure that traffic can be relayed to silent hosts that enables discovering such hosts with an apt response, such as an ARP response. Additionally or alternatively, broadcasting into the fabric may be performed differently depending on whether the UMR packet is from inside or outside of the fabric.

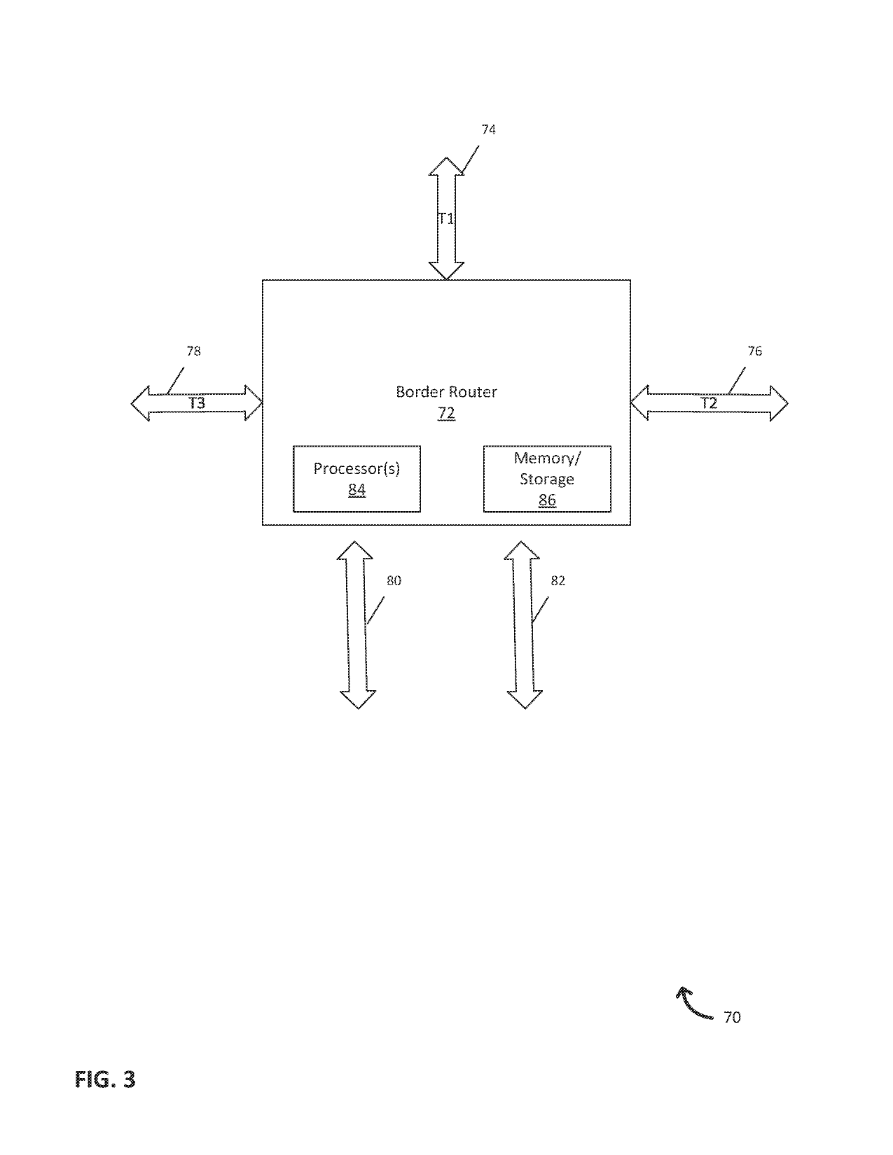

FIG. 3 is a diagram 70 of connections of a border network device 72 (e.g., the border network device 18 and/or any other network device in the VXLAN). As illustrated, the border network device 72, as a vtep, uses a first tunnel (T1) 74 to communicate with the wide area network to the remote fabric (e.g., the fabric 14) via a border network device (e.g., the border network device 20) of the remote fabric within the VXLAN. The border network device 72 also utilizes a second tunnel (T2) 76 to communicate with a first access switch/leaf (e.g., network device 22) and a third tunnel (T3) 78 to communicate with a second access switch/leaf (e.g., network device 26) within the VXLAN. The border network device 72 may include one or more access ports 80 that provide additional connections to the border network device 72. For instance, the one or more access ports 80 may include ethernet ports, universal serial bus (USB) ports, and/or other ports for transporting data into/from the border network device other than through T174,T276, orT378. The border network device 72 further includes one or more processors 84 used to control operations of the border network device 72, such UMR publication, relaying messages, implementing a split horizon rule, and other general messaging operations. The border network device 72 may also include memory/storage 86 that is a non-transitory and computer-readable medium that may be used to store instructions that, when executed by the processor 84 causes the processor to perform network device operations. The memory/storage 86 may also be used to store configuration settings/registers for how the border network device 72 is to function. Additionally or alternatively, the memory/storage 86 may be used to store routing tables/MAC tables for the border network device 72. The memory/storage 86 may include random-access memory (RAM), non-volatile random-access memory (NVRAM), read-only memory (ROM), flash memory, and/or any other memory or storage medium suitable for storing instructions, registers, or any of the foregoing discussed stored elements.

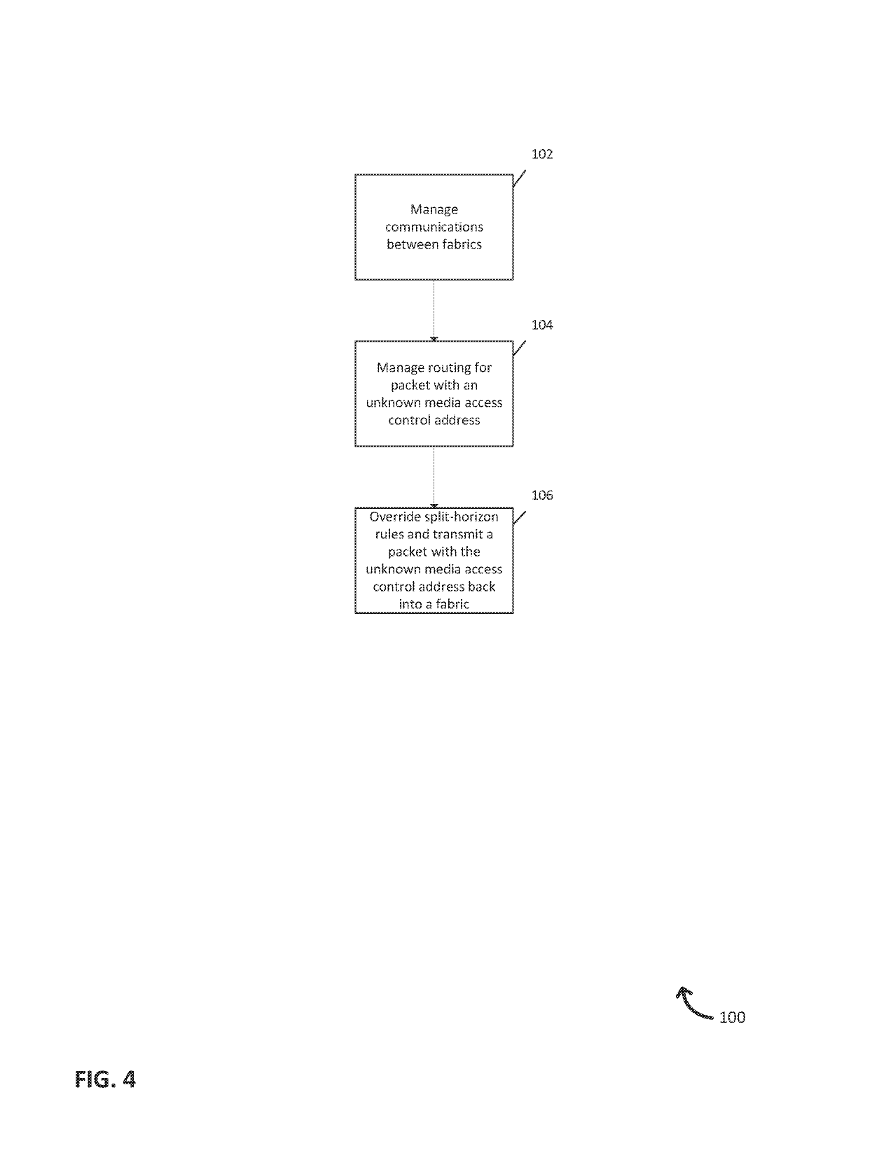

FIG. 4 is a block diagram of a process 100 that a LAN network device (e.g., the border network device 18, the border network device 72, or any other network device of the VXLAN) implements to perform packet routing. For instance, the process may be implemented by the processor 84 using instructions stored in the memory/storage 86. The border network device 72 at least partially manages communications between fabrics (block 102). For instance, in the implementation of FIGS. 1 and 2, the border network device 18 at least partially manages communications between the fabric 12 and the fabric 14 by providing a pipeline between the fabric 12 and the fabric 14. The border network device 72 may implement a split horizon rule that prevents retransmitting messages back into the fabric for at least some message types (e.g., broadcast and multicast messages) from which the messages are received. Specifically, the border network device 72 may encapsulate and send messages from the fabric 12 to the fabric 14 for decapsulation and consumption in the fabric 14.

The border network device 72 also manages routing for a packet with an unknown MAC address (block 104). Managing routing for the packet may include storing UMRs in the memory/storage 86 and publishing the UMRs to other devices in the fabric 12. These UMRs instruct these devices to use the UMRs as default routes for unicast messages with an unknown destination MAC. In other words, the border network device 72 controls routing of unicast messages with unknown destination MACs. However, when receiving these UMR-based unicast messages, the border network device 72 may ignore and/or override the split horizon rule to retransmit the UMR-based unicast messages back to the fabric 12.

Thus, the border network device 72 may receive unicast messages with unknown MAC addresses. The border network device 72 may check these unicast messages against its stored and published UMRs to determine whether the message is UMR-based. The border network device 72, on receipt of a packet from within a first fabric (e.g., fabric 12) of the fabrics targeting a host with the unknown MAC address (i.e., is a UMR-based unicast message), overrides the split horizon rule and transmits the packet back into the first fabric from the LAN network device (block 106). For instance, the split horizon rule may be ignored for the border network device 72 for UMR-based messages and sent back into the fabric 12. Moreover, the border network device 72 may follow the split horizon rule for multicast and broadcast messages while overriding the split horizon rule for unicast messages. In other words, the border network device 72 may retransmit UMR-based unicast messages back into the fabric 12 from which the messages have been received while not retransmitting multicast and broadcast messages back into the fabric 12 from which the messages have been recevied. As previously noted, the targeted host may have an unknown MAC due to host being a silent host that has not sent or received a message via the fabrics. Transmitting the packet back into the fabric may include transmitting using a first subset of tunnels of the fabric when the packet is received from a first tunnel in the fabric or transmitting using a second subset of the tunnels of the fabric when the packet is received from a second tunnel in the fabric. For instance, if the packet is received from T174, it is transmitted via T276 and T378 into the fabric while it transmitted from T276 into the fabric when received from T378. Additionally or alternatively, if the packet is received from T276, it is transmitted via T378 into the fabric while it transmitted from T276 into the fabric when received from T378.

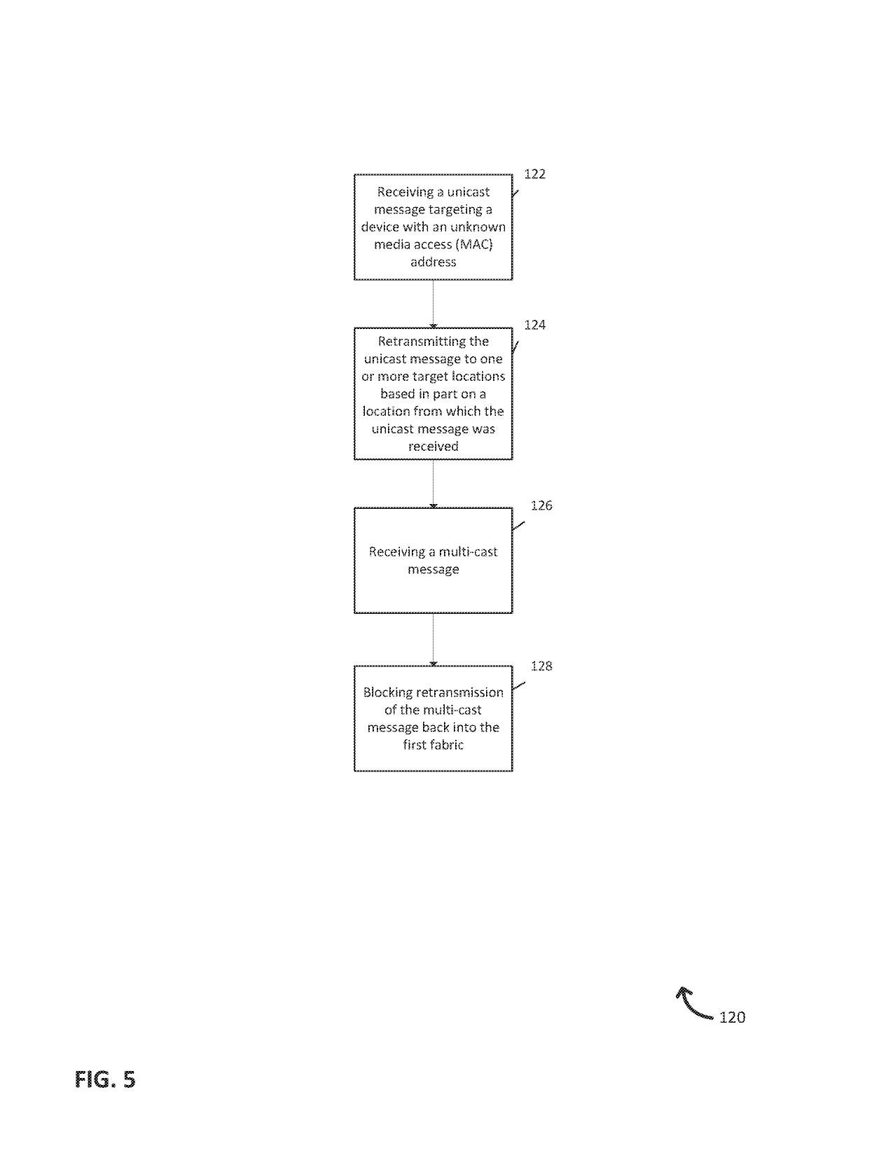

FIG. 5 is a block diagram of a process 100 that a network device (e.g., the border network device 18, the border network device 72, or any other network device of the VXLAN) implements to perform packet routing. For instance, the process may be implemented by the processor 84 using instructions stored in the memory/storage 86 used to implement a network device. The network device receives a unicast message targeting a device with an unknown media access control (MAC) address (block 122). The unicast message may be received from a first fabric of network devices. For instance, the border network device 72 may check the unicast message target against UMR lists stored in the border network device 72 as part of UMR publication.

The network device retransmits the unicast message to one or more target locations based at least in part on a location from which the unicast message was received by the network device (block 124). For instance, the network device may provide a first connection via a first tunnel between the network device and a border network device (e.g., border network device 20) of a second fabric (e.g., fabric 14) of network devices. In such a situation, the network device is also a border network device that provides a bridge between the first fabric and the second fabric. The network device may also provide a second connection via a second tunnel between the network device and a first device of the first fabric of network devices and provide a third connection via a third tunnel between the network device and a second device of the first fabric of network devices. In such an implementation, the network device may receive the unicast message via the second tunnel and retransmit the unicast message to the one or more target locations via the third tunnel.

The network device also receives a multicast message (block 126). For instance, the multicast message may also be received from the first fabric. The multicast message may be a multicast message or a broadcast message. Since the network device overrides the split horizon rule for unicast messages while maintaining the split horizon rule for multicast messages, the network device blocks transmission of the multicast message back into the first fabric in compliance with the split horizon rule (block 128).

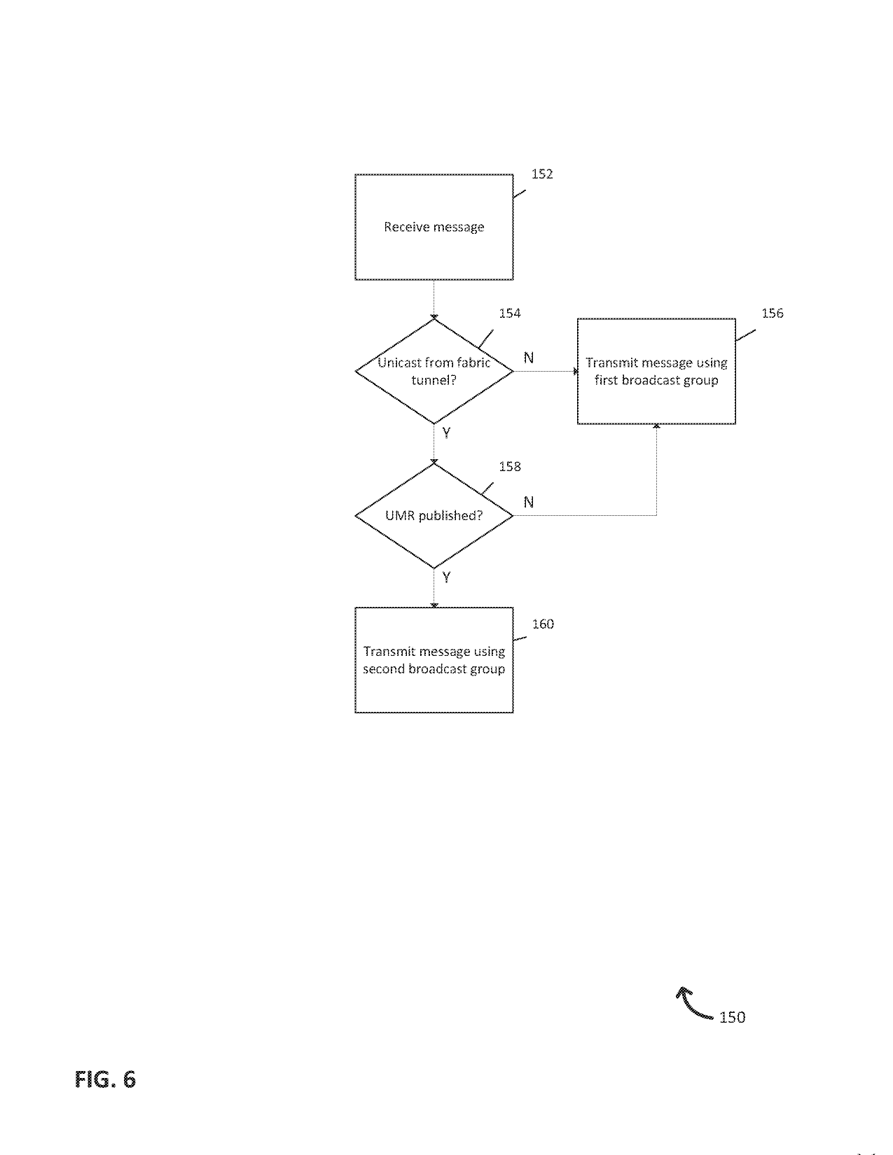

FIG. 6 is a flow diagram of a process 150 that may be deployed as a decision tree by a network device (e.g., the border network device 18, the border network device 72, or any other network device of the VXLAN) to perform packet routing and transmission of packets according to corresponding replication/broadcast groups. The process 150 may be implemented by the processor 84 using instructions stored in the memory/storage 86 used to implement network device functionality. The network device receives a message (block 152). The network device determines whether the received message is unicast from inside a fabric via a fabric tunnel (block 154). For example, the network device may determine whether the message is 1) unicast based on message headers and 2) from a tunnel corresponding to an internal vtep of a fabric of a VXLAN based on which tunnel decapsulation is used. For instance, the border network device 18 may determine whether any received message is a unicast message received via T276 or T278 from network devices 22 or 26 of the fabric 12. If the message is not unicast or is not received from an internal vtep or carries a VNI that does not correspond to the VNI, the network device transmits the message using a first broadcast group (block 156). The first broadcast group (or replication group) may be a default broadcast group that is assigned as part of normal provisioning that may include split horizon logic. In other words, this first broadcast group is used to redirect BUM traffic for broadcast and multicast traffic and for unicast traffic transmitted to the border network device from outside of the fabric. Furthermore, if the message is received from outside the VXLAN and/or from the access ports 80 and/or 82, the network device transmits the message using the first broadcast group.

When the received packet is a unicast message with an unknown MAC from an internal vtep, the border network device determines whether a UMR is published by the border network device (block 158). If no UMR is published by the border network device, the border network device may transmit the packet using the first broadcast group. If the border network device has published a UMR, the border network device transmits a message using a second broadcast group (block 160). The network device may be configured to utilize one of multiple secondary broadcast groups. These second broadcast group(s) may override the default action (e.g., a drop) of the packet due to a split horizon rule if using the first broadcast group. This differentiation into different broadcast groups facilitates replicating the packet carrying an unknown destination MAC back into the fabric to other vteps while still blocking wasted duplicative retransmitting of broadcast and multicast messages back into the fabric.

As a specific example using FIG. 2 for illustration, the network device 22 may transmit a packet, such as packet 52, to the border network device 18 via T276 of FIG. 3. If the packet 52 contains a broadcast message, a multicast message, and/or a unicast message with a known MAC, the border network device 18 may transmit the message/packet using the first/default/provisioned broadcast group. However, since the packet 52 was received from an internal vtep (e.g., the network device 22), any unicast messages with an unknown MAC are further examined to determine whether a second/secondary broadcast group without the split horizon rule is to be used in place of the first/default/provisioned broadcast group. Since T2 76 and T378 belong to the same fabric 12, they are in the same split horizon/broadcast group. If transmitting a message using the first broadcast group, any BUM traffic received from T2 76 would not be published back to T378 and vice versa. However, since the border network device has secondary broadcast group(s), it can use those broadcast groups for retransmitting back into the fabric 12. For instance, a first secondary broadcast group may include T2 76 while a second secondary broadcast group may include T3 78. In some implementations, T276 and T378 may be included in the same secondary broadcast group. Alternatively, T276 and T3 78 may be included in different secondary broadcast groups that may be similarly named (e.g., RG-VNI40-1 and RG-VNI40-2) where a wildcard may be used to replace any characters that are different if the border network device is capable of processing packets in ASCII or other similar character designations. In these secondary broadcast groups, the other tunnels of the fabric may be used to redirect packets rather than dropping packets due to the split horizon rule. For instance, if the packet 52 is received at the border network device 18 from the network device 22 via T276, the border network device 18 may redirect the packet 52 to the network device 26 via T378 rather than dropping the packet as would be followed using the default broadcast group. Likewise, if the packet is received at the border network device 18 from the network device 26 via T3 78, the border network device 18 may redirect the packet to the network device 22 via T276 rather than dropping the packet as would be followed using the default broadcast group.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A local area network (LAN) network device, configured to:
manage communications between a first fabric in a LAN and a second fabric in the LAN using a split horizon rule that block retransmission of a message to network devices that have transmitted, wherein the LAN network device is part of the first fabric;
manage routing for packets with an unknown media access control (MAC) address; and
on receipt of a packet from within the first fabric for a host with the unknown MAC address, override the split horizon rule and transmit the packet back into the first fabric from the LAN network device based at least in part on the receipt of the packet for the host with the unknown MAC address.

2. The LAN network device of claim 1, comprising a tunnel endpoint that encapsulates and decapsulates packets for communication between an underlay network and an overlay network.

3. The LAN network device of claim 2, wherein the overlay network comprises a virtual extensible LAN (VXLAN) virtual network.

4. The LAN network device of claim 2, wherein the underlay network comprises the first fabric.

5. The LAN network device of claim 1, wherein the first fabric comprises a network of connected devices.

6. The LAN network device of claim 1, wherein the LAN network device is configured to follow the split horizon rule for multicast and broadcast messages, and the packet for the host with the unknown MAC address comprises unicast messages targeting the host.

7. The LAN network device of claim 1, wherein the host is a silent host that has not sent or received a message via the first fabric or the second fabric.

8. The LAN network device of claim 1, wherein managing routing for packets comprises publishing unknown MAC routes (UMRs) to be used as default routes for unicast messages with an unknown destination MAC from other devices in the LAN to instruct the other devices to send the unicast messages with the unknown destination MAC to the LAN network device.

9. The LAN network device of claim 1, wherein managing communications between the first fabric and the second fabric comprises using the split horizon rule for broadcast messages and multicast messages to block transmission of the broadcast messages and multicast messages back into the first fabric from the LAN network device.

10. The LAN network device of claim 1, wherein transmitting the packet back into the first fabric comprises:
transmitting using a first subset of tunnels of the first fabric when the packet is received from a first tunnel in the first fabric, or
transmitting using a second subset of the tunnels of the first fabric when the packet is received from a second tunnel in the first fabric, wherein the first subset of the tunnels includes the second tunnel, and the second subset of the tunnels includes the first tunnel.

11. The LAN network device of claim 10, wherein the second subset of the tunnels comprises the second tunnel, and the first subset of the tunnels comprises the first tunnel.

12. A method, comprising:
receiving, by a network device and from a first fabric of network devices, a unicast message targeting a device with an unknown media access control (MAC) address;
retransmitting, by the network device, the unicast message to one or more target locations based at least in part on a location from which the unicast message was received by the network device;
receiving, at the network device and from the first fabric, a multicast message; and
blocking retransmission of the multicast message back into the first fabric.

13. The method of claim 12, comprising, providing, by the network device:
a first connection via a first tunnel between the network device and a border network device of a second fabric of network devices, wherein the network device is a border network device of the first fabric that provides a bridge between the first fabric and the second fabric;
a second connection via a second tunnel between the network device and a first device of the first fabric of network devices; and
a third connection via a third tunnel between the network device and a second device of the first fabric of network devices.

14. The method of claim 13, wherein receiving the unicast message comprises receiving the unicast message via the second tunnel, and retransmitting the unicast message to the one or more target locations comprises retransmitting the unicast message via the third tunnel.

15. The method of claim 13, comprising:
receiving, at the network device and from the border network device of the second fabric via the first tunnel, an additional unicast message targeting an additional device with an additional unknown MAC address; and
retransmitting the additional unicast message via the second tunnel or the third tunnel within the first fabric.

16. The method of claim 13, comprising publishing an unknown MAC route (UMR) table to a network device of the second tunnel.

17. The method of claim 12, wherein the multicast message comprises a broadcast message that is broadcast to all nodes of a virtual local area network (VLAN).

18. A non-transitory, computer-readable medium, comprising computer-readable instructions that, when executed by one or more processors, cause the one or more processors to:
receive, by a network device, a unicast message targeting a device with an unknown media access control (MAC) address;
retransmit the unicast message to one or more target locations based at least in part on a location from which the unicast message was received by the network device;
receive, at the network device and from a first fabric of network devices, a multicast message; and
block retransmission of the multicast message back into the first fabric from the network device.

19. The non-transitory, computer-readable medium of claim 18, wherein the instructions are configured to cause the one or more processors to:
implement a first connection via a first tunnel between the network device and a border network device of a second fabric of network devices, wherein the network device is a border network device of the first fabric that provides a bridge between the first fabric and the second fabric;
implement a second connection via a second tunnel between the network device and a first device of the first fabric of network devices; and
implement a third connection via a third tunnel between the network device and a second device of the first fabric of network devices.

20. The non-transitory, computer-readable medium of claim 19, wherein the instructions are configured to cause the one or more processors to:
receive, at the network device and from the border network device of the second fabric via the first tunnel, an additional unicast message targeting an additional device with an additional unknown MAC address; and
retransmit the additional unicast message via the second tunnel and the third tunnel within the first fabric.
